(19) United States
(12) Patent Application Publication
(10) Pub. No.: US 2015/0295841 A1
(43) Pub. Date: Oct. 15, 2015

(54) EFFICIENT PACKET AGGREGATION USING DYNAMIC WAIT TIME

(71) Applicant: QUALCOMM Incorporated, San Diego, CA (US)

(72) Inventors: Kiran Neelisetty, Hyderabad (IN); Sriman Miryala, Hyderabad (IN); Ashwani Kumar Dwivedi, Hyderabad (IN)

(73) Assignee: QUALCOMM Incorporated, San Diego, CA (US)

(21) Appl. No.: 14/252,471

(22) Filed: Apr. 14, 2014

(51) Int. Cl. H04L 12/875; H04W 28/10; H04L 12/891

(52) U.S. Cl. CPC H04L 47/56; H04L 47/41; H04W 28/10; H04W 80/02

(57) ABSTRACT

Methods, systems, and devices are described for determining when to aggregate packets (e.g., transmit an aggregated packet) at a protocol layer based on an indication of whether more packets are available for transfer from a higher layer. In aspects, the protocol layer may receive an indication from the higher layer of whether additional packets are present in a second packet queue of the higher layer for transfer to the protocol layer. Based on the received indication, the protocol layer may determine when to aggregate the packets in the protocol layer queue into an aggregated packet (e.g., whether to transmit the aggregated packet upon receipt of the indication, etc.). Determining when to aggregate packets in the protocol layer based on the indication may override conventional packet aggregation conditions such as an aggregation wait time, an aggregation window size (minimum or maximum), and the like.

### BACKGROUND

The following relates to wireless communications, and in particular to techniques for more efficient packet aggregation. Wireless communications systems are widely deployed to provide various types of communication content such as voice, video, packet data, messaging, broadcast, and so on. These systems may be multiple-access systems capable of supporting communication with multiple users by sharing the available system resources (e.g., time, frequency, and power). A wireless network, for example a Wireless Local Area Network (WLAN), such as a Wi-Fi network (IEEE 802.11) may include an access point (AP) that may communicate with one or more stations (STAs) or mobile devices. The AP may be coupled to a network, such as the Internet, and enable a mobile device to communicate via the network (and/or communicate with other devices coupled to the access point).

APs and STAs may aggregate or combine different groups of data, such as packets, before transmitting the data to increase data transfer rates, throughput, etc., and to generally increase communication performance. Packet aggregation may be performed at different layers within devices implementing 802.11 standards. For example, packets may be aggregated at the Medium Access Control (MAC) layer, which may be known as MAC service data unit (MSDU) aggregation. Packets may alternatively be aggregated at the Physical (PHY) layer of the device, which may be known as MAC protocol data unit (MPDU) aggregation. MSDU and/or MPDU aggregation may allow an 802.11 device to send multiple packets in a single frame or in multiple frames separated by Reduced Inter-Frame Spacing (RIFS) time.

Current MSDU and MPDU aggregation techniques may include gathering one or more packets at a packet queue of the aggregating protocol layer received from an higher layer. The higher layer may be an application layer, a Transmission Control Protocol (TCP) stack, a User Datagram Protocol (UDP) stack, or a MAC layer, for example. The packets in the aggregating protocol queue may be aggregated and transmitted upon the occurrence of one or more aggregation conditions. The aggregation conditions may include not receiving any more packets for a pre-determined wait time, reaching a certain number of packets in the queue (e.g., window size), or other similar conditions or limits Current aggregation techniques, however, may result in unwanted delay in transmitting one or more aggregated packets, for example due to waiting for one or more aggregation conditions to be satisfied before transmitting the aggregated packet. In some cases, the wait time termination condition may be satisfied before aggregation at the lower layer reaches the window size. As a result, the lower layer may have to wait for the fixed amount of time even though there are no more packets ready at the higher layer. This may result in less than optimal utilization of the transmission medium, increased power consumption, etc.

### SUMMARY

The described features generally relate to one or more improved systems, methods, and/or apparatuses for determining when to aggregate packets (e.g., transmit an aggregated packet) at a protocol layer based on an indication of whether more packets are available for transfer from a higher layer. In aspects, the protocol layer may receive an indication from the higher layer of whether additional packets are present in a second packet queue of the higher layer for transfer to the protocol layer. Based on the received indication, the protocol layer may determine when to aggregate the packets in the protocol layer queue into an aggregated packet (e.g., whether to transmit the aggregated packet upon receipt of the indication, etc.). In some embodiments, aggregating packets based on an indication that no additional packets are available for transfer from the higher layer to the protocol layer may override conventional packet aggregation conditions such as an aggregation wait time, an aggregation window size, and the like.

In some embodiments, aggregation may be performed in the PHY layer, which may generate aggregated MPDUs (AMPDUs) for transmission over a physical interface (e.g., WLAN radio, etc.). In this instance, the higher layer providing the indication of additional available packets may be the application layer, the session, transport, or network layer (e.g., TCP stack, UDP stack, etc.), or the MAC layer. The PHY layer may utilize the indication of whether additional packets are available in a higher layer to determine when to transmit aggregated packets over the physical interface. Additionally or alternatively, aggregation may be performed at the MAC layer, which may aggregate MSDUs into aggregated MSDUs (AMSDUs), which may utilize the indication to determine when to transfer the AMSDUs to the PHY layer for transmission over the physical interface.

In some embodiments, the indication of whether at least one additional packet is present in the higher layer packet queue (e.g., a second packet queue) may be included in at least one packet transferred from the higher layer to the protocol layer. In one aspect, the indication may include a flag in a packet header of the at least one packet transferred from the higher layer to the protocol layer. The indication may also indicate information related to a number of packets (e.g., relative to one or more thresholds, etc.) available in the higher layer queue, for example, to be passed to the protocol layer queue (e.g., a first packet queue). In some embodiments, the higher layer may determine the value of the indication based in part on a known or predicted pattern of packets becoming available (e.g., generated, received, etc.) at the higher layer queue.

In some embodiments, a method for packet aggregation in a wireless communication system may include aggregating, in a first packet queue of a protocol layer, at least one packet received from a higher layer for transmission over a medium into an aggregated packet. The method may also include receiving, at the protocol layer, an indication from the higher layer of whether at least one additional packet is present in a second packet queue of the higher layer for transfer to the protocol layer. The method may further include determining when to transmit an aggregated packet including the at least one packet received from the higher layer based at least in part on the indication.

In some embodiments, the method includes receiving the at least one packet from the higher layer, where the indication is included in the at least one received packet. The indication included in the at least one packet may be a flag in a packet header of the at least one received packet. Receiving the indication may include receiving information indicating a number of packets of the at least one additional packet in the second packet queue of the higher layer. The information indicating the number of packets of the at least one additional packet may include an indication of whether the number of packets is greater than a threshold. The method may include determining the indication, by the higher layer, based at least in part on a pattern of packets received at the second packet queue.

In some embodiments, determining when to transmit an aggregated packet includes overriding at least one packet aggregation condition based at least in part on the indication that no additional packets are present in the second packet queue of the higher layer for transfer to the protocol layer. The at least one packet aggregation condition may include at least one of an aggregation wait time or an aggregation window size.

In some embodiments, a method for packet aggregation may also include transmitting the aggregated packet to a destination device over a WLAN radio channel. In some aspects, the higher layer may include a MAC layer and the protocol layer may include a PHY layer. In other embodiments, the higher layer may include an application layer, a UDP layer, or a TCP layer, while the protocol layer may include a MAC layer or a PHY layer. In some aspects, the higher layer and the protocol layer may be part of a device, such as a base station or a mobile device. In yet some aspects, the at least one packet may include at least one MPDU, while the aggregated packet may include an AMPDU for transmission over a WLAN.

In some embodiments, a wireless communication device may include a protocol layer including a protocol interface to receive at least one packet from a higher layer for transmission over a medium. The at least one packet may include an indication from the higher layer indicating whether at least one additional packet is present in a second packet queue of the higher layer for transfer to the protocol layer. The protocol layer may further include a packet aggregation queue, which is in communication with the protocol interface, to aggregate the at least one received packet into an aggregated packet. The protocol layer may additionally include a packet aggregation manager, which is in communication with the protocol interface and the packet aggregation queue, to determine when to instruct the packet aggregation queue to aggregate the at least one packet received from the higher layer based at least in part on the indication.

In some aspects, the protocol layer may include a MAC layer or a PHY layer. The indication may include information associated with a number of packets of the at least one additional packet in the second packet queue of the higher layer. In some embodiments, the indication may be set by the higher layer based at least in part on a pattern of packets received at the second packet queue.

In some aspects, determining when to instruct the packet aggregation queue to aggregate the at least one packet includes overriding at least one packet aggregation condition based at least in part on the indication indicating that no additional packets are present in the second packet queue of the higher layer for transfer to the protocol layer. The at least one packet aggregation condition may include at least one of an aggregation wait time or an aggregation window size.

In some embodiments, a computer program product operable on a wireless communication device may include a non-transitory computer-readable medium storing instructions for aggregating, in a first packet queue of a protocol layer, at least one packet into an aggregated packet. The at least one packet may be received from a higher layer for transmission over a medium. The non-transitory computer-readable medium may also store instructions for receiving, at the protocol layer, an indication from the higher layer of whether at least one additional packet is present in a second packet queue of the higher layer for transfer to the protocol layer. The non-transitory computer-readable medium may additionally store instructions for determining when to transmit an aggregated packet including the at least one packet received from the higher layer based at least in part on the indication.

Further scope of the applicability of the described methods and apparatuses will become apparent from the following detailed description, claims, and drawings. The detailed description and specific examples are given by way of illustration only, since various changes and modifications within the spirit and scope of the description will become apparent to those skilled in the art.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a block diagram of a wireless communications system in accordance with various embodiments;

FIG. 2 shows a block diagram of an example of wireless communications between an AP and an STA in accordance with various embodiments;

FIG. 3 shows a block diagram of an STA and an AP in communication with one another in accordance with various embodiments;

FIG. 4 shows a block diagram illustrating the transfer of packets between one or more layers of a device in accordance with various embodiments;

FIG. 5 shows a block diagram illustrating the transfer of packets between an higher layer and a protocol layer of a device relative to time in accordance with various embodiments;

FIG. 6 shows a flow diagram illustrating the transfer of packets between an higher layer and a protocol layer of a device in accordance with various embodiments;

FIG. 7 shows a flow diagram for attaching an indication of whether more packets are present in an application layer queue for transfer to a protocol layer queue in accordance with various embodiments;

FIG. 8 shows a flow diagram for determining when to transmit an aggregated packet at a PHY layer based on a received indication from an application layer in accordance with various embodiments;

FIG. 9 is a block diagram illustrating a device for determining when to transmit an aggregated packet at a protocol layer of the device based on a received indication from a higher layer in accordance with various embodiments;

FIG. 10 is a block diagram illustrating another example of a device for determining when to transmit an aggregated packet at a protocol layer of the device based on a received indication from a higher layer in accordance with various embodiments;

FIG. 11 shows a block diagram of a device that may be configured for determining when to transmit an aggregated packet at a protocol layer of the device based on a received indication from a higher layer in accordance with various embodiments; and

FIGS. 12 and 13 illustrate flowcharts of methods for determining when to transmit an aggregated packet at a protocol layer of the device based on a received indication from a higher layer in accordance with various embodiments.

### DETAILED DESCRIPTION

The described features generally relate to one or more improved systems, methods, and/or apparatuses for determining when to aggregate packets (e.g., transmit an aggregated packet) at a protocol layer based on an indication of whether more packets are available for transfer from a higher layer. The described techniques may enable more time and power efficient packet aggregation resulting in improved throughput and better utilization of transmission medium resources. In particular, a communications device, such as an AP, or a mobile device or STA, may receive one or more packets in a protocol layer queue of the device, for transmission over a wireless medium, from a higher layer. The protocol layer may also receive an indication from the higher layer of whether at least one additional packet is present in a second packet queue of the higher layer for transfer to the protocol layer. Based on the received indication, the protocol layer may determine when to aggregate and send (e.g., transmit or send to a lower layer, etc.) the one or more packets in the protocol layer queue. The term “higher layer” is not intended to convey that he higher layer is above a certain logical layer or implemented using particular components. Thus, “higher layer” means any layer above the instant protocol layer in an N-layer protocol stack (e.g., the Open Systems Interconnection (OSI) model, and may be dependent on context (e.g., any layer above the aggregating protocol layer). The described protocol layers and higher layers may be implemented using any suitable components (e.g., hardware, firmware, software, etc.).

In some embodiments, the aggregating protocol layer may be the PHY layer of an AP or mobile device and the higher layer may be the application layer, a session, transport, or network layer (e.g., TCP stack, UDP stack, etc.), or the MAC layer. The higher layer may indicate whether more packets (e.g., MPDUs, etc.) are available for passing down to the PHY layer. When more packets are indicated as available, the PHY layer may continue to wait for more packets and may perform aggregation based on other conditions (e.g., wait time, window size, etc.). Based on an indication that no more packets are available for transfer from the higher layer to the PHY layer, the PHY layer may aggregate the one or more MPDUs into an AMPDU and transmit the AMPDU. Using the described techniques, power usage for MPDU aggregation may be improved by allowing the PHY layer to more intelligently decide when to transmit an AMPDU, and when to wait for more packets before transmitting the AMPDU.

In some embodiments, the aggregating protocol layer may be the MAC layer and the higher layer be the application layer, a session, transport, or network layer (e.g., TCP stack, UDP stack, etc.). The indication may indicate whether more information (e.g., packets, etc.) is available at the higher layer to be passed down to the MAC layer as MSDUs. The MAC layer may use the indication to determine whether to aggregate packets in the MAC queue as an AMSDU and transfer the AMSDU to the PHY layer for transmission over a physical interface, or to wait for more packets from the higher layer.

In some embodiments, the indication may be a flag included in the data packets (e.g., in an MPDU, MSDU, etc.) that indicates whether there is more data present at the higher layer to be passed to the lower layer. In one aspect, the flag may be included in a header of the one or more packets. When the indication indicates that there are no more packets present in the higher layer to be passed to the protocol layer, the protocol layer may aggregate the received packets into an aggregated packet (e.g., AMPDU, AMSDU, etc.) and send (e.g., transmit, transfer to a lower layer, etc.) the aggregated packet. In one aspect, the indication may override one or more packet aggregation conditions. The packet aggregation conditions may include a wait time, which may be re-started from the time of reception of each packet and may be predetermined (e.g., 6 milliseconds (ms)). Other packet aggregation conditions may include a window size (e.g., a maximum number of bytes for an aggregated packet, minimum number of packets received before aggregation is performed, etc.).

In one aspect, the indication may include information related to the number of packets present at the higher layer (e.g., number of packets, quantized number of packets, whether the number of packets is above or below a threshold, etc.). In this scenario, the information may be used by the aggregating protocol layer to determine whether to wait for additional packets before aggregating received packets and/or before sending the aggregated packet.

Increased performance using a packet indicator may be a function of the data patterns coming from higher layers or applications and noise in the environment. In noisy environments, the STA may have significantly fewer transmit opportunities and more efficient aggregation may allow the STA to transmit as much data possible in one opportunity. For intermittent data patterns, the described techniques may enable the STA to avoid waiting for aggregation timeouts, which may reduce power consumption and potentially increase throughput.

The following description provides examples, and is not limiting of the scope, applicability, or configuration set forth in the claims. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments. As referred to herein, a WLAN connection or link may be synonymous with a Wi-Fi, Wi-Fi Direct, P2P connection or group, Wi-Fi Display, Miracast, or other WLAN communication technologies. For the purposes of explanation, the described methods, systems, and devices refer specifically to WLAN; however, other radio communication or access technologies may be compatible with and implemented using the described techniques.

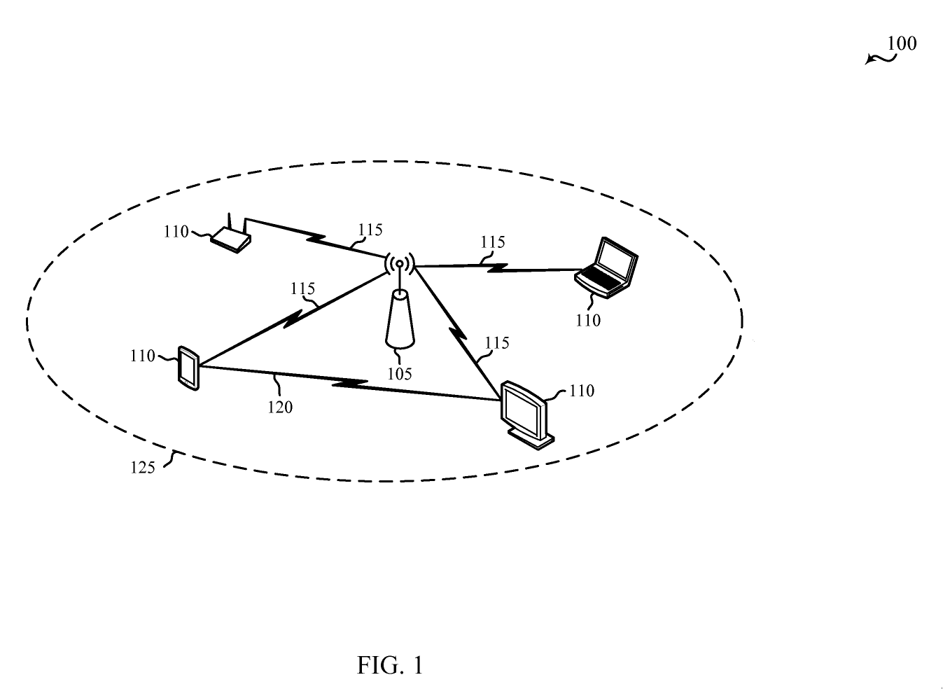

Referring first to FIG. 1, a block diagram illustrates an example of a WLAN or Wi-Fi network 100 such as, e.g., a network implementing at least one of the IEEE 802.11 family of standards. The network 100 may include an access point (AP) 105 and one or more wireless devices or stations (STAs) 110, such as mobile stations, personal digital assistants (PDAs), other handheld devices, netbooks, notebook computers, tablet computers, laptops, display devices (e.g., TVs, computer monitors, etc.), printers, etc. While only one AP 105 is illustrated, the network 100 may have multiple APs 105. Each of the wireless devices 110, which may also be referred to as a wireless station, a mobile station (MS), a mobile device, an access terminal (AT), a user equipment (UE), a subscriber station (SS), or a subscriber unit, may associate and communicate with an AP 105 via a communication link 115. Each AP 105 has a coverage area 125 such that stations 110 within that area can typically communicate with the AP 105. The devices 110 may be dispersed throughout the coverage area 125. Each device 110 may be stationary or mobile.

Although not shown in FIG. 1, a station 110 can be covered by more than one AP 105 and can therefore associate with one or more APs 105 at different times. A single AP 105 and an associated set of stations may be referred to as a basic service set (BSS). An extended service set (ESS) is a set of connected BSSs. A distribution system (DS) (not shown) is used to connect APs 105 in an extended service set. A coverage area 125 for an access point 105 may be divided into sectors making up only a portion of the coverage area (not shown). The system 100 may include access points 105 of different types (e.g., metropolitan area, home network, etc.), with varying sizes of coverage areas and overlapping coverage areas for different technologies. Although not shown, other wireless devices can communicate with the AP 105.

While the devices 110 may communicate with each other through the AP 105 using AP links 115, each device 110 may also communicate directly with one or more other devices 110 via a direct wireless link 120. Two or more devices 110 may communicate via a direct wireless link 120 when both devices 110 are in the AP coverage area 125 or when one or neither device 110 is within the AP coverage area 125 (not shown). Examples of direct wireless links 120 may include Wi-Fi Direct connections, connections established by using a Wi-Fi Tunneled Direct Link Setup (TDLS) link, and other P2P group connections. The wireless devices 110 in these examples may communicate according to the WLAN radio and baseband protocol including physical and MAC layers from IEEE 802.11, and its various versions including, but not limited to, 802.11b, 802.11g, 802.11a, 802.11n, 802.11ac, 802.11ad, 802.11ah, etc. In other implementations, other peer-to-peer connections and/or ad hoc networks may be implemented in system 100.

The communication networks that may accommodate some of the various disclosed embodiments may be packet-based networks that operate according to a layered protocol stack. Packetizing may divide long messages or blocks of data into smaller messages for delivery to other layers and devices. For example, communications at the session, transport, or network layers may be IP-based. These layers may control the reliability of a given link through flow control, segmentation or de-segmentation, and error control. Some protocols are state- and connection-oriented. This means that the layer can keep track of the packets and retransmit those that fail. For example, the layer may provide acknowledgement of the successful packet transmission and may send the next packet if no errors occurred. At each level, two entities (layer-N peers) exchange protocol data units (PDUs) by means of a layer-N protocol. A service data unit (SDU) is the payload of a PDU, transmitted unchanged to a peer entity. The SDU is a unit of data that has been passed down from one layer to the next lower layer, and which the lower layer encapsulates into a PDU. Layer N-1 adds headers or footers, or both, to the SDU, composing a PDU of layer N-1. The added headers or footers make it possible to get the data from a source to a destination. Thus, the PDU at a layer N becomes the SDU of layer N-1.

In some cases, it may be beneficial for devices 110 and AP 105 to communicate information by aggregating one or more packets, for example, to improve throughput, etc. Current aggregation techniques may include aggregation conditions or triggers that when satisfied, indicate to the protocol layer of the mobile device 110 or AP 105 when to aggregate packets and/or transmit aggregated packets. The aggregation conditions may include a maximum wait time, a window size (e.g. maximum or minimum number of packets, etc.), or other conditions. Packet aggregation based on these aggregation conditions, however, may result in less than optimal utilization of the transmission medium. For example, the protocol layer may wait until a wait time has elapsed before aggregating packets even though no more packets are being transferred to the protocol layer. This may result in unwanted delays, reduced throughput, etc. Another example may include the protocol layer waiting until a maximum or minimum window size is satisfied before aggregating packets, even though no more packets are available for transfer to the protocol layer. This may similarly result in unwanted delays, reduced throughput, etc.

Some or all of the above noted issues with respect to current aggregation techniques based on one or more aggregation conditions may be remedied (e.g., by increasing throughput, etc.), by utilizing an indication of whether more packets are available for transfer from a higher layer to inform the decision of when to aggregate packets (e.g., transmit an aggregated packet) at the protocol layer. By using these techniques, which will be described in greater detail below, STAs 110 and APs 105 of network 100 may increase throughput and overall communication performance.

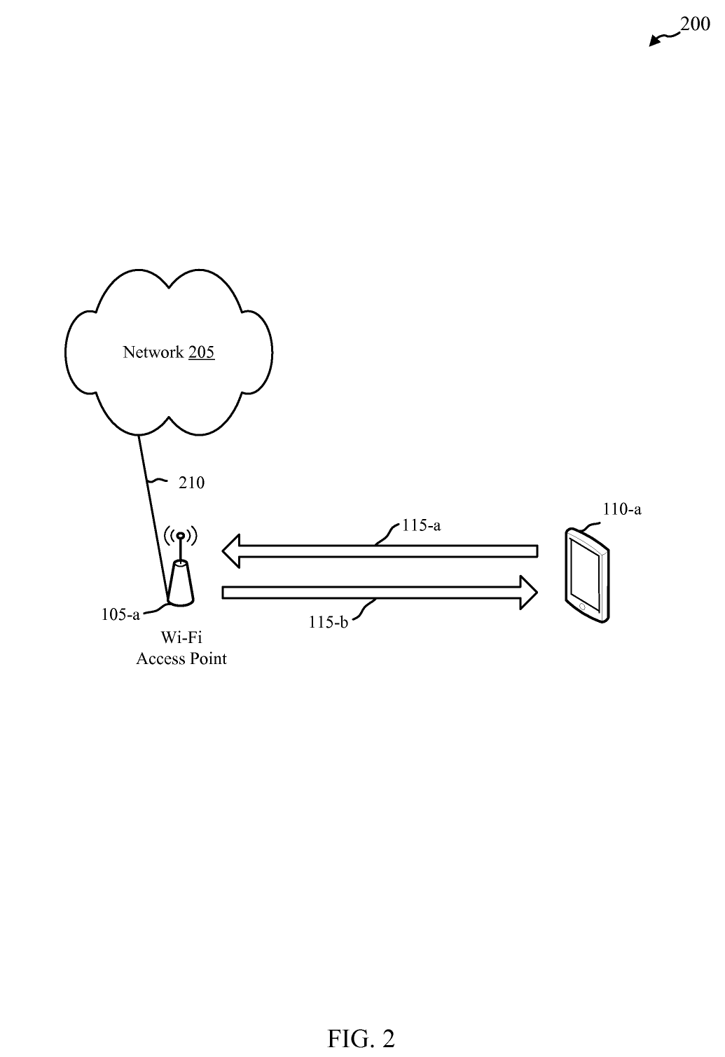

Referring now to FIG. 2, a block diagram 200 illustrates an example of wireless communications between an AP 105-a and a mobile device or STA 110-a in accordance with various embodiments. The mobile device 110-a and the AP 105-a may be examples of device 110 and AP 105 described in reference to FIG. 1. The AP 105-a may be in communication with a network 205 via link 210, which may be either a wired or wireless link. The AP 105-a and the mobile device 110-a may communicate via communication links or paths 115-a and 115-b. Link 115-a may originate at the mobile device 110-a and communication link 115-b may originate at the AP 105-a.

Communication via the aggregation techniques described herein will be described below from the perspective of the mobile device 110-a. However, it should be understood that the AP 105-a may also utilize similar aggregation techniques to realize similar benefits.

In one aspect, the mobile device 110-a may send information to the AP 105 via link 115-a. The mobile device 110-a may be configured to aggregate one or more packets to improve throughput of communication over link 115-a. The mobile device 110-a may aggregate packets in the MAC layer, such as by aggregating one or more MSDUs into an AMSDU. The AMSDU may then be transferred to the PHY layer to be communicated over link 115-a. The mobile device may additionally or alternatively aggregate packets in the PHY layer, such as by aggregating one or more MPDUs into an AMPDU. The AMPDU may be communicated over link 115-a by the PHY layer. The decision of when to aggregate the MSDUs and/or the MPDUs may be based on, for example, satisfaction of one or more aggregation conditions. In some cases, the aggregation conditions (e.g., wait time, window size, etc.) may be predetermined or set for a device, such as STA 110 or AP 105, or for a network, without taking into account data arriving at the aggregating layer, different link conditions etc. Waiting for one or more aggregation conditions to be satisfied may introduce delay, reduce throughput, etc. for the transmitting device.

Some or all of these deficiencies and others may be addressed by improved systems, methods, and/or apparatuses for determining when to aggregate packets (e.g., transmit an aggregated packet) at a protocol layer based on an indication of whether more packets are available for transfer from a higher layer. In aspects, the aggregating protocol layer (e.g., the MAC or PHY layer) may receive an indication from the higher layer of whether additional packets are present in a second packet queue of the higher layer for transfer to the protocol layer. Based on the received indication, the protocol layer may determine when to aggregate the packets in the protocol layer queue into an aggregated packet (e.g., whether to transmit the aggregated packet over link 115-a upon receipt of the indication, etc.). Determining when to aggregate packets in the protocol layer based on the indication may override conventional packet aggregation conditions such as an aggregation wait time, an aggregation window size (minimum or maximum), and the like.

The AP 105-a may implement similar techniques, as described above, for packet aggregation over link 115-b to the mobile device 110-a, to realize similar improvements in communication performance and throughput, for example.

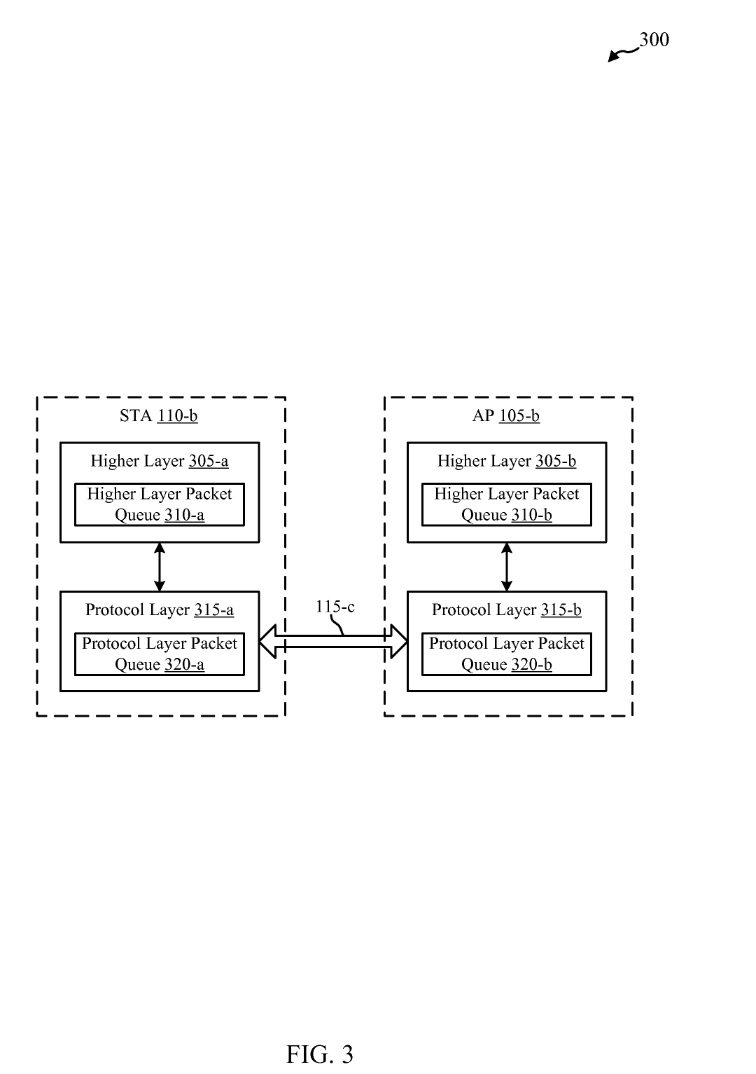

Referring next to FIG. 3, a block diagram 300 illustrates a STA or mobile device 110-b in communication with an AP 105-b via communication link 115-c. The STA 110-b and the AP 105-b may be examples of devices 110 and APs 105 described above in reference to FIG. 1 and/or 2. The STA 110-b may include an higher layer 305-a having an higher layer packet queue 310-a and a protocol layer 315-a having a protocol layer packet queue 320-a. Similarly, the AP 105-b may include an higher layer 305-b having an higher layer packet queue 310-b and a protocol layer 315-b having a protocol layer packet queue 320-b. The protocol layers 315 of STA 110-b and AP 105-b may communicate with each other via communication link 115-c, which may be an example of communication link 115 described in reference to FIGS. 1 and/or 2 above. While the described environment illustrates communication between an STA 110 and an AP 105, it should be noted that the described techniques can also be applied to communication between STAs 110 (e.g., using a peer-to-peer interface such as Wi-Fi Direct, etc.) or communication between APs 105.

The higher layer 305 of STA 110-b or AP 105-b may have (e.g., generate, receive, etc.) one or more packets, located or stored in the higher layer packet queue 310 for transmission over interface 115-c to the other device. The higher layer packet queue 310 may transfer the one or more packets to the protocol layer 315, which may store the received packets in a protocol layer packet queue 320 for processing, formatting and transmission over link 115-c to the AP 105-b or STA 110-b. Processing of the one or more packets at the protocol layer 315 for transmission may include packet aggregation (e.g., MPDU aggregation, MSDU aggregation, etc.). To improve communication of the one or more packets, e.g., to increase throughput over link 115-c, the higher layer 305 may indicate to the protocol layer 315 whether one or more additional packets are available at the higher layer (e.g., present in the higher layer packet queue 310).

In some embodiments, the indication whether one or more additional packets are available for transfer from the higher layer 305 may be applied in conjunction with (e.g., overriding) one or more packet aggregation conditions at the protocol layer 315 to increase aggregation performance. The packet aggregation conditions may dictate when a protocol layer, such as a MAC layer or a PHY layer, are to aggregate one or more packets and/or transmit the one or more aggregated packets. The packet aggregation conditions may include an aggregation wait time, which may be predetermined by the network, the STA 110-b, the AP 105-b, or other network entity, for example. The packet aggregation conditions may also include maximum window size (e.g., maximum number of packets, maximum amount of data), that can be aggregated into a single aggregated packet. The window size may be a function of communication protocols implemented by the STA 110-b or AP 105-b, a function of hardware of the STA 110-b or AP 105-b, communication bandwidth of link 115-c, etc. In other cases, the packet aggregation conditions may include a minimum window size (e.g., minimum amount of packets to transfer without a wait time), or other values or metrics.

In some cases, the indication may indicate that no more packets are present in the higher layer packet queue 310, for example via a flag attached to one or more packets set to a logical “0.” In this case, the protocol layer 315 may aggregate all the packets currently in the protocol layer packet queue 320 and/or transmit the aggregated packet via link 115-c. In this scenario, the indication may override one or more packet aggregation conditions, for example a predetermined wait time. In some embodiments, the protocol layer 315 performs aggregation and/or transmission of the aggregated packet upon receipt of the indication, without having to wait the predetermined wait time in instances where it is highly likely that no more packets will arrive within the wait time. In other embodiments, the protocol layer 315 reduces the wait time for additional packets upon receipt of the indication. In another example, the indication may override a window size aggregation condition. In this scenario, the protocol layer packet queue 320 may be waiting until a minimum or maximum window size (e.g., number of packets, number of bytes, etc.) has been satisfied, which may similarly introduce unnecessary delays in the aggregation process if no more packets are en route to the protocol layer packet queue 320. Accordingly, the protocol layer packet queue 320 may decide to aggregate packets based on the indication rather than wait for the window size aggregation condition to be satisfied.

In some embodiments, the indication may indicate that more packets are present in the higher layer packet queue 310, for example, via a flag attached to one or more packets set to a logical “1.” Based on this indication, the protocol layer 315 may delay aggregating the packets in the protocol layer packet queue 320 and/or delay transmitting the aggregated packet and may continue to wait for additional packets to be received from the higher layer packet queue 310. In this scenario, packet aggregation conditions (e.g., wait time, window size, etc.) may be followed in conjunction with the indication. For example, the protocol layer packet queue 320 may wait for another packet until a wait timer is satisfied, and then aggregate the packets in the queue 320 when the wait timer expires and no more packets have been received. In other cases, the indication may override one or more packet aggregation conditions. For example, the protocol layer packet queue 320 may increase the wait timer or wait for another packet indefinitely (irrespective of a wait timer). In other scenarios, the protocol layer packet queue 320 may prioritize and/or apply the indication in conjunction with one or more packet aggregation conditions in various ways.

In some embodiments, the higher layer packet queue 310 may indicate whether one or more additional packets are present in the higher layer packet queue 310 via a flag, for example attached to one or more packets being transferred from to the protocol layer packet queue 320 of the STA 110-b. In a particular example, the higher layer packet queue 310 may attach or set a flag in a header of the one or more packets based on a determination of how many packets are currently in the higher layer packet queue 310. In one aspect, the higher layer packet queue 310 may attach or include an indication in every packet transferred to the protocol layer packet 320 of the STA 110-b. Alternatively, the indication including the number of remaining packets in the higher layer packet queue 310 may be sent with only some of the packets transferred from the higher layer packet queue 310 to the protocol layer packet queue 320, such as with every other packet, periodically based on a timer, etc. In some embodiments, the higher layer packet queue 310 may adjust when to send the indication based on the number of packets remaining in the higher layer packet queue 310. In this scenario, the indication may be sent, for example, when the number of packets remaining in the higher layer packet queue 310 satisfies a threshold, such as a minimum number of packets or a maximum number of packets, etc.

In one aspect, the indication may include information related to the number of packets present at the higher layer packet queue 310 (e.g., number of packets, quantized number of packets, whether the number of packets is above or below a threshold, etc.). In this scenario, the information may be used by the aggregating protocol layer 315 to determine whether to wait for additional packets before aggregating received packets and/or before sending the aggregated packet.

In some embodiments, the indication may be sent separately from the one or more packets being transferred from the higher layer packet queue 310 to the protocol layer packet queue 320. For example, the indication may be sent as a parameter of a service primitive or other communication message between the higher layer 305 and the protocol layer 315.

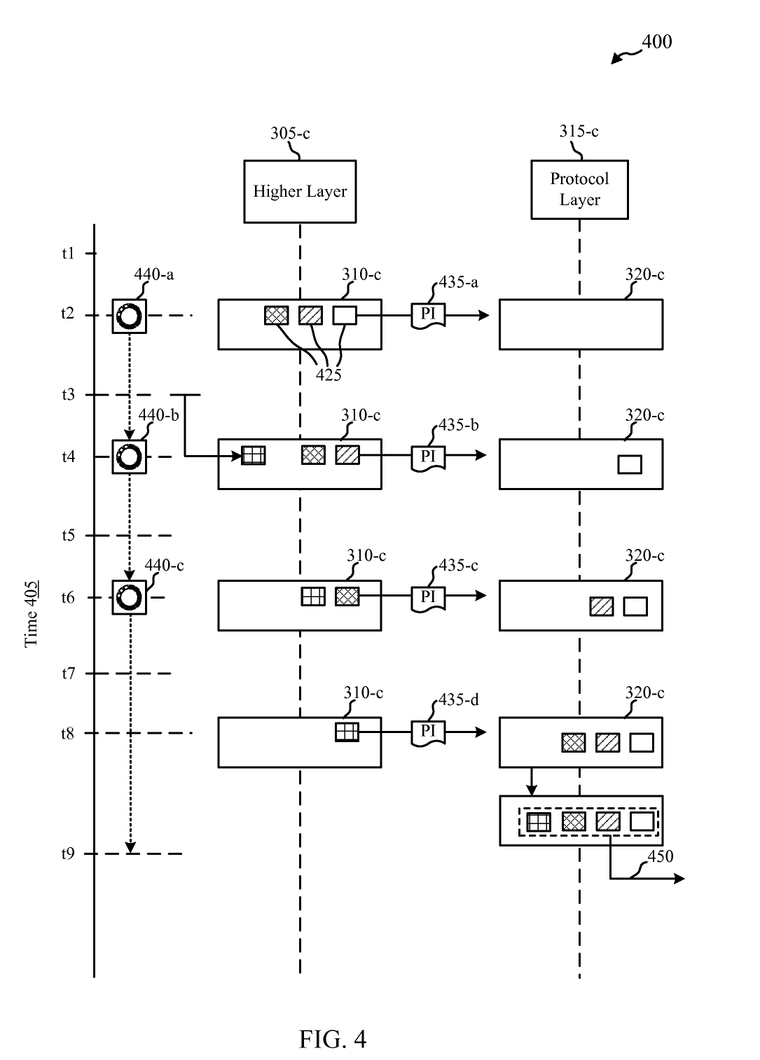

Referring next to FIG. 4, a block diagram 400 illustrates the transfer of packets between higher layer 305-c and an aggregating protocol layer 315-c relative to time 405, in accordance with various embodiments. Higher layer 305-c and aggregating protocol layer 315-c may be higher layer 305 and aggregating protocol layer 315, respectively, of a STA 110 or AP 105 described above with reference to FIG. 1, 2, or 3, for example. Higher layer 305-c may include a higher layer packet queue 310-c and protocol layer 315-c may include a protocol layer packet queue 320-c.

At a first time t1, the higher layer packet queue 310-c may contain a number of packets 425 and the protocol layer packet queue 320-c may be empty. For ease of illustration, the higher layer packet queue 310-c is shown as containing three packets 425 at time t1. At time t2, the higher layer 305-c may send the first packet 425 with packet indication (PI) 435-a to the protocol layer 315-c. Because there are additional packets remaining in the higher layer packet queue 310-c after the transfer of the packet 425 at time t1, the higher layer 305-c may set the packet indicator 435-a to a logical state (e.g., a logical “1”) indicating that there are additional packets available at the higher layer 305-c for transfer to the protocol layer 315-c.

Upon receiving the packet 425, the protocol layer 315-c may start a wait timer 440-a. The expiration of the wait timer 440-a may be set as a packet aggregation condition, such that if the timer 440-a expires before any more packets 425 are received at the protocol layer 315-c, the protocol layer 315-c may aggregate the packets 425 in the protocol layer packet queue 320-c (e.g., send or transmit an aggregated packet). As illustrated, the timer 440-a may be set to expire at a time t5 and the protocol layer 315-c may store the received packets and wait for the timer to expire at t5 before aggregating the packets stored in the protocol layer packet queue 320-c.

However, at time t4, the higher layer 305-c may transfer another packet 425 with a packet indication 435-b to the protocol layer packet queue 320-c. Upon receipt of the packet 425 at time t4, the protocol layer 315-c may restart the timer 440-b, now set to expire and trigger packet aggregation at time t7. Again, the higher layer 305-c may set the packet indication 435-b to a logical state indicating that there are additional packets available at the higher layer 305-c for transfer to the protocol layer 315-c.

As illustrated in FIG. 4, additional packets may be generated or received in higher layer 305-c. For example, an additional packet 425 may be put in the higher layer packet queue 310-c at time t3. For ease of illustration, only one packet 425 is described as being received at the higher layer packet queue 310-c during time period 405. However, it should be understood that any number of packets 425 may be received at the higher layer packet queue 310-c and processed according to the described techniques.

At time t6, the higher layer 305-c may transfer another packet 425 from the higher layer packet queue 310-c to the protocol layer 315-c prior to the expiration of the timer 440-b. Packet indication 435-c may be sent with the packet 425. Because there is still one packet in higher layer packet queue 310-c, packet indication 435-c may indicate again that there are additional packets available at the higher layer 305-c for transfer to the protocol layer 315-c. The protocol layer 315-c may again reset the timer 440-c upon receipt of the packet 425 at time t6, this time to expire at time t9. The protocol layer 315-c may continue to wait for additional packets until the timer 440-c expires.

Prior to time t9, the higher layer 305-c may transfer the last packet 425 from the higher layer packet queue 310-c to the protocol layer 315-c at time t8. Packet indication 435-d may be sent with the packet 425 at time t8. Because the packet 425 transferred at time t8 is the last packet in the higher layer packet queue 310-c, the higher layer 305-c may set the packet indication 435-d to a logical state indicating that there are no additional packets available at the higher layer 305-c for transfer to the protocol layer 315-c (e.g., a logical “0”).

The protocol layer may receive the packet 425 transferred from the higher layer 305-c at time t8 and, based on the packet indication 435-d sent with the packet 425, decide to aggregate the packets 425 in the protocol layer packet queue 320-c at time t8. For example, the protocol layer 315-c may generate an aggregated packet 450 and transfer the aggregated packet from the protocol layer packet queue 320-c to a destination for the aggregated packet (e.g., by transmitted the aggregated packet 450 over a physical interface such as one of links 115, transferring the aggregated to a lower layer for additional processing prior to transmission over a physical interface, etc.).

Without receiving the packet indication 435-d, the protocol layer 315-c would instead wait for other aggregation conditions to be met before performing aggregation of the received packets 425. For example, the protocol layer 325-c would reset the timer 440 at time t8, and wait for the timer to expire before performing aggregation. The packet indications 435 allow the protocol layer 315-c to perform packet aggregation and/or transmission of an aggregated packet upon receipt of a packet indication indicating that no additional packets are available in the higher layer for transfer to the protocol layer. In these instances, it may be unlikely that an additional packet will be received within the wait time, and therefore not waiting for expiration of the wait timer when no more packets are available at the higher layer may increase utilization of transmission resources in most instances.

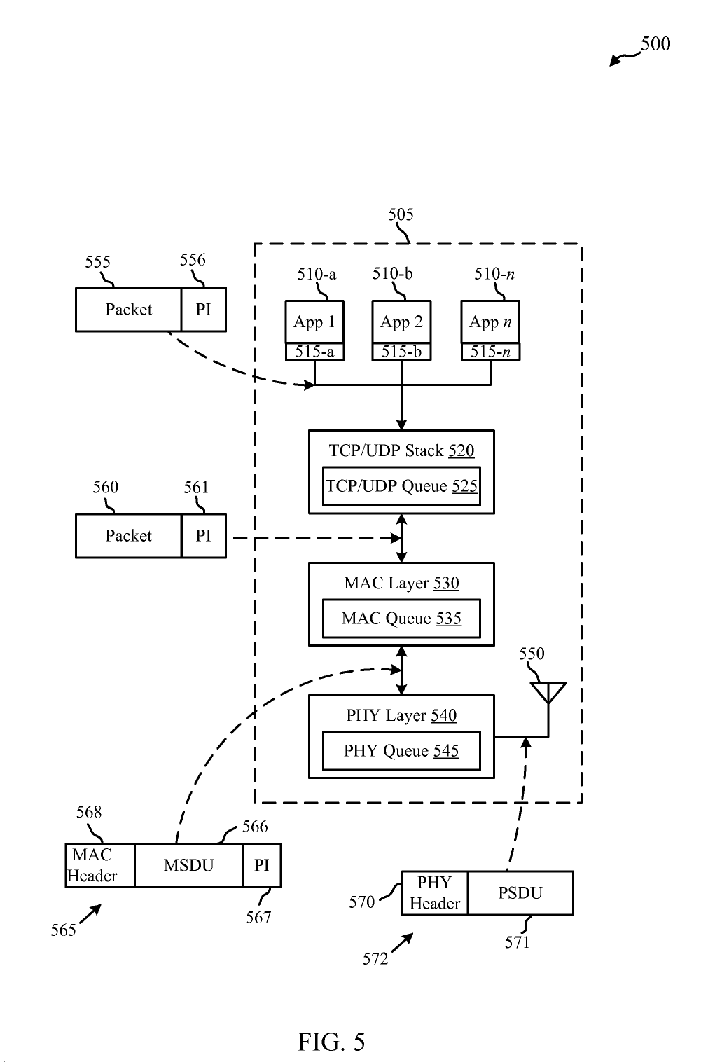

Referring next to FIG. 5, a block diagram 500 illustrates a device 505 for deciding when to aggregate one or more packets (e.g., transmit the aggregated packet) based on an indication from a higher layer, in accordance with various embodiments. The device 505 may be an example of an STA 110 or AP 105 described above in reference to FIG. 1, 2, or 3.

As illustrated, device 505 may implement multiple applications 510, such as 510-a, 510-b, through 510-n. Each of these applications may have a packet queue 515, such as packet queues 515-a, 515-b, through 515-n. One or more of applications 510-a, 510-b, through 510-n may have data to send, for example, to another device, such as an STA 110, and/or AP 105 as described above in reference to FIGS. 1, 2, and/or 3. The one or more applications 510 may collect, process, format, etc., the information to be transmitted into one or more packets 555 in the packet queue 515. The application 510 or the packet queue 515 may attach a packet indication 556 to one or more packets 555, with the PI 556 indicating whether the packet queue 515 of the application 510 has one or more additional packets to transmit. The PI 556, in one aspect, may be a flag set to “1” to indicate that more packets are present in the packet queue 515, or set to “0” to indicate that no more packets are present in the packet queue 515. In some embodiments, the PI 556 may be included in a header of the packet 555. In other embodiments, the PI 556 may be attached to another portion of packet 555, for example appended to the end of packet 555.

The one or more applications 510 (e.g., one or more application queues 515) may pass the one or more packets 555 including one or more PIs 556 to a lower layer to be prepared for transmission to a target device. In one aspect, the one or more packets 555 with one or more PIs 556 may be passed to the MAC layer 530 of device 505. The MAC layer 530 may attach a MAC header 568 to each MSDU 566 sent to the PHY layer 540, and the packet structure of the MAC header 568 and the MSDU 566 may be known as an MPDU 565.

In some embodiments, the MAC layer 530 may perform aggregation on the one or more packets 560 received from the applications 510 or TCP/UDP stack 520. Techniques for packet aggregation in the MAC layer may be known as MSDU aggregation. In these examples, aggregated MSDUs (AMSDUs) (not shown) may be sent from the MAC layer 530 to the PHY layer 540 for transmission. The one or more packets may be aggregated by the MAC queue 535 into one or more AMSDUs based on the PI 556, 561 attached to the one or more packets 555, 560 via the techniques described above, for example, by overriding one or more packet aggregation conditions. The MAC layer 530 may attach a MAC header 568 to the AMSDUs to form an MPDU 565 and pass the MPDU 565 to the PHY layer 540 to be processed for transmission via one or more antennas 550 to a target device. The PHY layer 540 and/or PHY layer queue 545 may attach a PHY header 570 to the MPDU (which may be known as a PSDU 571 for transmission from the PHY layer). The combination of the PHY header 570 and the PSDU 571 may be a PPDU 572. The PPDU 572 may then be transmitted by the one or more antennas 550 to a target device (e.g., STA 110 or AP 105, etc.).

Additionally or alternatively, the PHY layer 540 may perform packet aggregation on MPDUs 565 received from the MAC layer 530. For example, the MSDUs 566/AMSDUs may be passed from the MAC layer 530 to the PHY layer as MPDUs 565. The MAC layer 530 may include PIs 567 to the MPDUs 565 that indicate whether one or more additional packets are available in the MAC layer queue 535 for transfer to the PHY layer 540.

The PHY layer 540 may utilize the PIs 567 to determine when to aggregate MPDUs 565 received from the MAC layer 530 into AMDPUs (not shown) for transmission via the one or more antennas 550. For example, when a PI 567 indicates no more MSDUs 566/AMSDUs available for transfer at the MAC layer 530, the PHY layer 540 may aggregate the MPDUs 565 in the PHY queue 545 into an AMPDU and transmit the AMPDU (e.g., in PPDU 572, etc.) over the physical interface. As described above, the PHY layer 540 may utilize the PIs 567 to override one or more packet aggregation conditions (e.g., wait time, window size, etc.).

In some embodiments, the one or more applications 510 may utilize known or determined patterns of data flow to set the one or more PIs 556. For example, an application 510 may access historical data of the type, size, frequency, etc., of information or packets being transferred from the application 510 to be transmitted to another device. This information may be accessed via local storage of device 505, via communication with a network in communication with device 505, etc. Based on this information, the application 510 may set the PIs 556. In some cases, pattern information related to packets being generated or transferred from application 510 may be used by the application 510 to set one or more PIs 556, for example when data is expected and/or when no packets are currently in the application queue 515. For example, a video encoding application may having timing information related to when video frames are about to be generated or when the last packet of a frame is generated and there may be delay before additional packets are generated for the next frame.

As illustrated, one or more applications 510 are shown as separate from a TCP/UDP stack 520. It should be appreciated, however, that that TCP/UDP stack 520 and/or the TCP/UDP queue 525 may be implemented in conjunction with one or more applications 510 and/or application queues 515. For example, one or more applications 510 and application queues 515 may be combined with one or more TCP or UDP stacks 520 and/or one or more TCP or UDP queues 4525 in the same component. In these instances, information may be collected in packet queue 525 (e.g., the TCP/UDP queue 525 may be same as queue 515, etc.).

In other embodiments, the TCP or UDP stack 520 may be separate from one or more applications 510, and/or may perform additional processing of the one or more packets 555 transferred from the one or more applications 510 or from other sources (e.g., networking protocols, services, etc.). In this scenario, the TCP/UDP stack 520 may receive the one or more packets 555 in the TCP/UDP queue 525. The TCP/UDP stack 520 may perform additional processing, such as flow control or segmentation/de-segmentation, on the one or more received packets 555. In some cases, the TCP/UDP stack 520 and/or queue 525 may generate the PI 561 or set PI 561 based on the PI 556 received from the one or more applications 510. In some embodiments, the TCP/UDP stack 520 and/or queue 525 may reformat (e.g., segmentation/de-segmentation, etc.) the one or more packets 555 and one or more PIs 556 into new packets 560 and PIs 561 based on the state of packets in the TCP/UDP queue 525, for example. In this scenario, one or more packets 560 and one or more PIs 561 may be passed to the MAC layer 530.

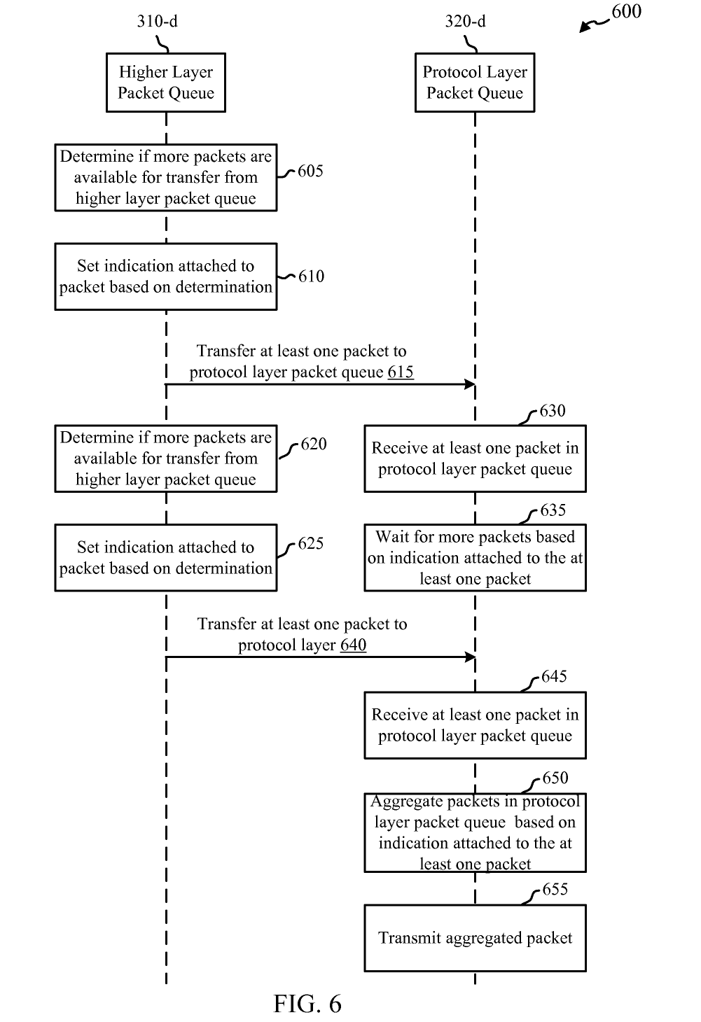

Referring next to FIG. 6, a block flow diagram illustrates a process 600 for determining when to aggregate packets (e.g., transmit an aggregated packet) at a protocol layer packet queue 320-d based on an indication of whether more packets are available for transfer from a higher layer packet queue 310-d, in accordance with various embodiments. The higher layer packet queue 310-d may include one or more aspects of higher layer packet queues 310 of STA 110-b and/or AP 105-b described in reference to FIG. 3, or one or more aspects of application queues 515, the TCP/UDP queue 525, and/or the MAC queue 535 described in reference to FIG. 5. The protocol layer packet queue 320-d may include one or more aspects of protocol layer packet queues 320 of STA 110-b and/or AP 105-b described in reference to FIG. 3, or aspects of the MAC queue 535 or PHY queue 545 described in reference to FIG. 5.

Process 600 may begin with the higher layer packet queue 310-d determining if more packets are available for transfer from the queue 310-d at block 605. This may include determining how many packets are in the queue 310-d, determining whether the data and/or packets in the queue 310-d are available for transmission in a given transport stream (e.g., not expired or already transmitted, etc.). Based on the determination at block 605, the higher layer packet queue 310-d may then set an indication of whether more packets are in the queue 310-d at block 610. In some instances, the indication may include a number of available packets in the queue 310-d, whether the number of packets satisfies one or more thresholds, etc. The higher layer packet queue 310-d may then transmit at least one packet with the indication set in block 610 to the protocol layer packet queue 320-d at 615.

The protocol layer packet queue 320-d may receive the at least one packet and the indication transmitted from the higher layer packet queue 310-d at block 630. In one example, the protocol layer packet queue 320-d may determine to wait for more packets from the higher layer packet queue 310-d based on the indication at block 635. The determination at block 635 may be based on the indication received from the higher layer packet queue 310-d, with the indication overriding one or more packet aggregation conditions, such as a wait time, a window size, etc., of the protocol layer packet queue 320-d.

Concurrently with operations 630 and 635 of the protocol layer packet queue 320-d, the higher layer packet queue 310-d may determine if more packets are available for transfer from the queue 310-d at block 620. In one example, the higher layer packet queue 310-d may determine that there are no more packets available in queue 310-d. Based on this determination, the higher layer packet queue 310-d may set a second indication attached to the last packet in the queue 310-d indicating that no more packets are available in queue 310-d at block 625. The higher layer packet queue 310-d may then transmit at least one packet with the indication set in block 625 to the protocol layer packet queue 320-d at block 640.

The protocol layer packet queue 320-d may receive the one or more packets and the indication transmitted at 640 by the higher layer packet queue 310-d, at 645. Based on the indication that no more packets are available in the queue 310-d, the protocol layer packet queue 320-d may aggregate the packets in the queue 320-d at block 650. The protocol layer packet queue 320-d may then transmit the aggregated packet at block 655, for example if the protocol layer packet queue 320-d is implemented in a PHY layer. In another example, if the protocol layer packet queue 320-d is implemented in a MAC layer, the queue 320-d may transfer the aggregated packet to the PHY layer to be transmitted.

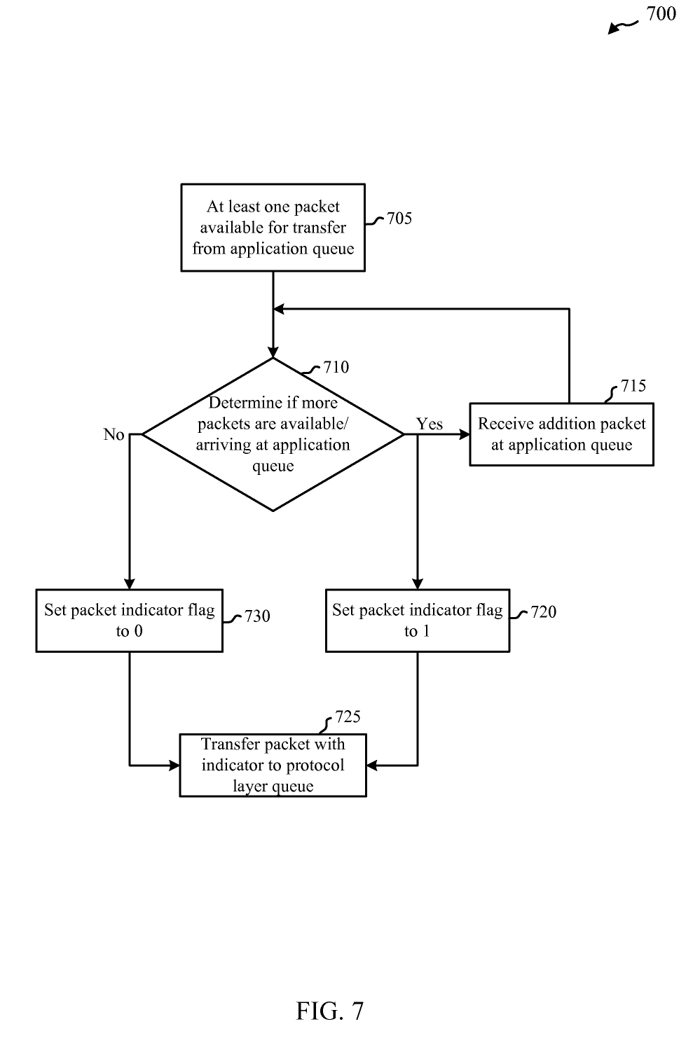

Referring next to FIG. 7, a block flow diagram illustrates a process 700 for setting an indication in an application of a device, such as an STA 110 or AP 105 of previous Figures, indicating whether more packets are available in the application to be transferred to a protocol layer of the device, in accordance with various embodiments. Process 700, for example, may be implemented by one or more of the higher layers 305 and/or the higher layer packet queues 310 of STA 110-b and/or AP 105-b described in reference to FIG. 3 or FIG. 6, or one or more applications 510 and/or application queues 515, and/or the TCP/UDP stack 520 and/or the TCP/UDP queue 525 described in reference to FIG. 5.

The process 700 may begin with there being at least one packet available for transfer from an application queue at block 705. The application queue may then determine if more packets are available and/or arriving at the application queue at block 710. The determination at block 710 may include determining whether more packets are currently in the application queue. The determination at block 710 may additionally include determining whether one or more packets are expected to be available based on known or predicted patterns of data flow arriving at the application queue. For example, the application queue may access historical data of the type, size, frequency, etc., of information or packets being transferred from the application queue to be transmitted to another device (e.g. an STA 110 or AP 105).

If the application queue determines that no more packets are available and/or arriving at the application queue at block 710, the queue may set an indicator flag to be included with the packet to a logical “0” at block 730. The queue may then transfer the packet with the indication to a protocol layer queue at 725, such as a PHY layer, for transmission to a recipient device, such as an AP 105 or STA 110.

If the application queue determines that there are more packets available and/or arriving at the application queue at block 710, the queue may set an indicator flag to be included with the packet to a logical “1” at block 720. The queue may then transmit the packet with the indication to a protocol layer queue at block 725, such as a PHY layer, for transmission to a recipient device, such as an AP 105 or STA 110. In addition to setting the packet indicator flag at block 720, the queue may also receive an additional packet at block 715. The process 700 may then return to block 710, where the queue may determine if more packets are available and/or arriving at the queue for transmission to a protocol layer queue. The queue may then set another indicator based on the determination at 710 and continue to loop through operations 710, 720, 725, and 715 until the queue determines that no more packets are available/arriving at the queue 710. The queue may then set the indicator to a logical “0” at 730 and transfer the packet with the indicator to the protocol layer queue 725, ending process 700.

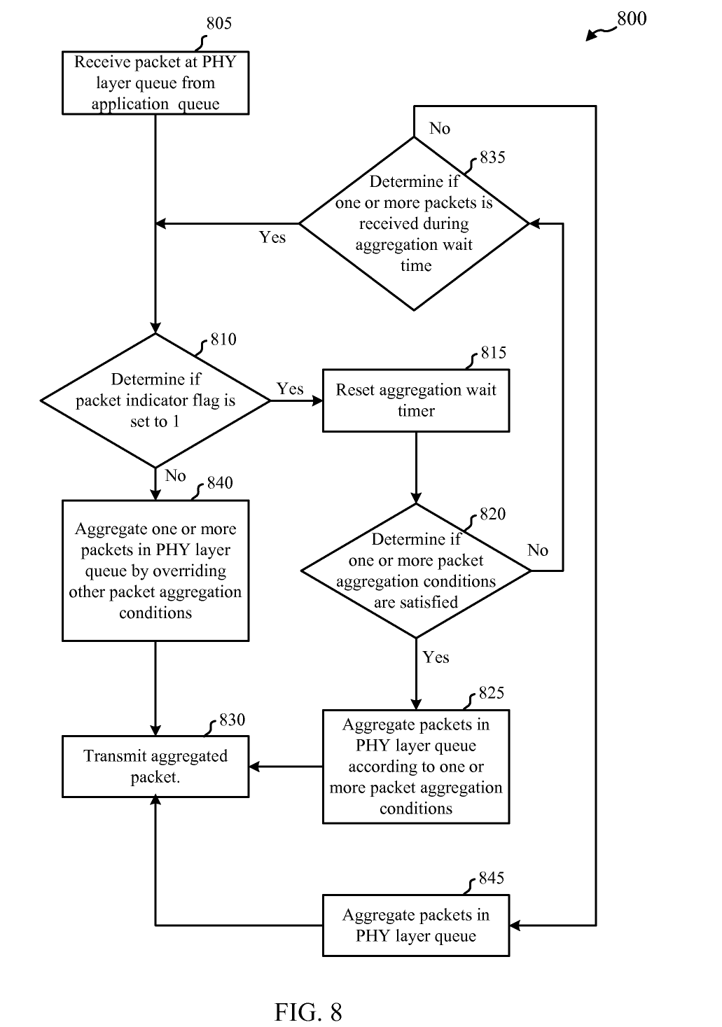

Referring next to FIG. 8, a block flow diagram illustrates a process 800 for determining when to aggregate packets in a PHY layer of a device, such as an STA 110 or AP 105 of previous Figures, based on an indication of whether more packets area available in an application layer sent from the application, in accordance with various embodiments. Process 800, for example, may be implemented by one or more of the protocol layers 315 and/or the packet queues 320 of STA 110-b or AP 105-b described in reference to FIG. 3 or FIG. 6, or the PHY layer 540 or the PHY queue 545 described in reference to FIG. 5.

The process 800 may begin with the PHY layer queue of a device, such as AP 105 or STA 110, receiving a packet with an indication (e.g., an indicator such as flag) of whether more packets are available in an application queue, from the application queue at block 805. The PHY layer queue may then determine if the packet indictor received with the packet is set to a logical “1,” at block 810.

If the PHY layer queue determines that the indictor is set to a logical “1,” the PHY layer queue may reset the aggregation wait timer at block 815. The PHY layer queue may then determine if one or more other packet aggregation conditions are satisfied, for example a maximum or minimum window size, or any other aggregations that are well known in the art, at block 820. In some implementations, if at least one aggregation condition is satisfied, the PHY layer queue may then aggregate the packets in the queue based on the at least one aggregation condition at block 825. The PHY layer queue may then transmit the aggregated packet at 830.

If the PHY layer queue determines that one or more other packet aggregation conditions are not satisfied, at block 820, the PHY layer queue may then determine if one or more packets are received during the aggregation wait time at block 835. If no packets are received during the aggregation wait time, in some instances the PHY layer queue may then aggregate the packets in the queue at block 845 and transmit the aggregated packet at block 830. However, if one or more packets are received during the aggregation wait time, the PHY layer may the determine if the packet indictor attached to the recently received packet is set to logical “1,” at block 810. In this way, the PHY layer queue may continue to delay aggregating packets in the queue based on the indicator sent with the received packets, for example by looping through operations 810, 815, 820, and 835, if the indicator does not contradict one or more packet aggregation conditions at 825.

In some embodiments, the packet indicator may override one or more packet aggregation conditions, such that the satisfaction of one or more packet aggregations may not result in the PHY layer queue deciding to aggregate the packets in the queue. In this scenario, instead of proceeding to block 825 from block 820, process 800 may proceed to block 835, as described above. In this way, the PHY layer queue may continue to delay aggregating packets in the queue based on the indicator sent with the received packets, for example by looping through operations 810, 815, 820, and 835, even if the indicator contradicts one or more packet aggregation conditions.

In some embodiments, the PHY layer queue may wait to receive one or more additional packets at block 835 irrespective of the aggregation wait timer, based on the packet indicator for the last received packet indicating that there are more packets available in the higher layer packet queue.

If the PHY layer queue determines that the indicator associated with a received packet is not set to a logical “1” at block 810, the PHY layer may decide to aggregate the packets in the queue according to the indicator irrespective of one or more packet aggregation conditions at block 840 (e.g., before an aggregation wait time has elapsed). The PHY layer queue may then transmit the aggregated packet at 830. In this way, the PHY layer queue may receive packets with an indicator set to a logical “1” and may continue to delay aggregating the received packets based on the received indicators. When, however, the indicator indicates that no more packets are available in an application queue, the PHY layer queue may then proceed to aggregate the packets according to the indicator 840 and transmit the aggregated packet 830.

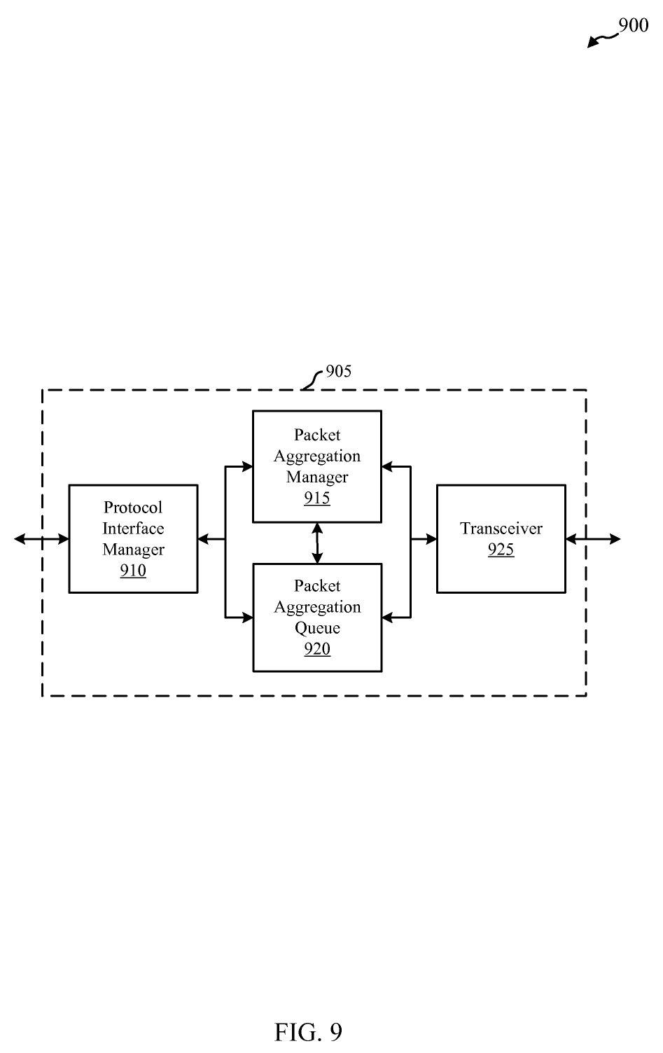

FIG. 9 shows a block diagram 900 of a device 905 for aggregating one or more packets based on an indication from an higher layer of whether more packets are available in the higher layer, in accordance with various embodiments. The device 905 may implement one or more aspects of the protocol layers 315 and/or the packet queues 320 of STA 110-b or AP 105-b described in reference to FIG. 3 or FIG. 6, or one or more aspects of the MAC layer 530 and/or MAC queue 535 or the PHY layer 540 and/or the PHY queue 545 described in reference to FIG. 5. The device 905 may further implement one or more aspects of process 800 described in reference to FIG. 8, and/or may be implemented in an STA 110 or an AP 105 described above in reference to previous Figures. The device 905 may include a protocol interface manager 905, a packet aggregation manager 915, a packet aggregation queue 920, and/or a transceiver 925, each of which, in embodiments, may be communicably coupled with any or all of the other components. In some embodiments, device 905 may represent a modem, for example, of an STA 110 or AP 105. In other cases, device 905 may represent the physical structure of a protocol layer, such as a MAC or PHY layer of an STA 110 or AP 105.

The protocol interface manager 910 may receive one or more packets from a higher layer, such as from one or more applications 510, a TCP/UDP stack 520, or a MAC layer 530 described above in reference to FIG. 5. The one or more packets may each include an indication of whether the higher layer (e.g., a queue of the higher layer), has additional packets to transfer to the device 905 (e.g., to the packet aggregation queue 920). In some cases, the indication may include a number of packets in the higher layer packet queue for transfer to device 905, an indication of whether the number of packets in the higher layer queue exceeds one or more thresholds, etc.

The protocol interface manager 910 may communicate the one or more received packets to the packet aggregation queue 920. The packet aggregation queue 920 may perform various operations to prepare the one or more received packets for transmission via the transceiver 925. The operations may include, for example, aggregating packets in the queue 920, attaching other information to the aggregated packet, such as header information, cyclic redundancy checking (CRC) information, etc. In some instances, the packet aggregation manger 915 may instruct the packet aggregation queue when to aggregate packets contained in the queue 920.

The protocol interface manager 910 may also communicate the indication information to the packet aggregation manager 915. Based on the indication, the packet aggregation manager 915 may instruct the packet aggregation queue 920 when to aggregate packets contained in the packet aggregation queue 920. For example, the packet aggregation manager 915 may implement some or all of the operations of process 800 described above in reference to FIG. 8. In some instances, the packet aggregation manager 915 may instruct the packet aggregation queue 920 to aggregate packets based on the received indication, with the received indication overriding one or more other packet aggregation conditions (e.g., a wait time, a window size, etc.). In this way, the device 905 may implement more efficient packet aggregation, by using the received indication from a higher layer of whether more packets are available for transfer to the device 905.

The packet aggregation queue 902 may receive an instruction from the packet aggregation manager 915 to aggregate packets in the queue 920 (for example, when the received indication indicates that no more packets are in an higher layer queue). The packet aggregation queue 902, after aggregating the packets in the queue 920 into one or more aggregated packets, may communicate the one or more aggregated packets to the transceiver 925 to be transmitted to a recipient device, (e.g., an STA 110 or AP 105). In some aspects, the one or more aggregated packets may be further encapsulated by another layer, for example a PHY layer in the case the packet aggregation queue 920 is implemented in a MAC layer, before being transmitted by the transceiver 925 (not shown).

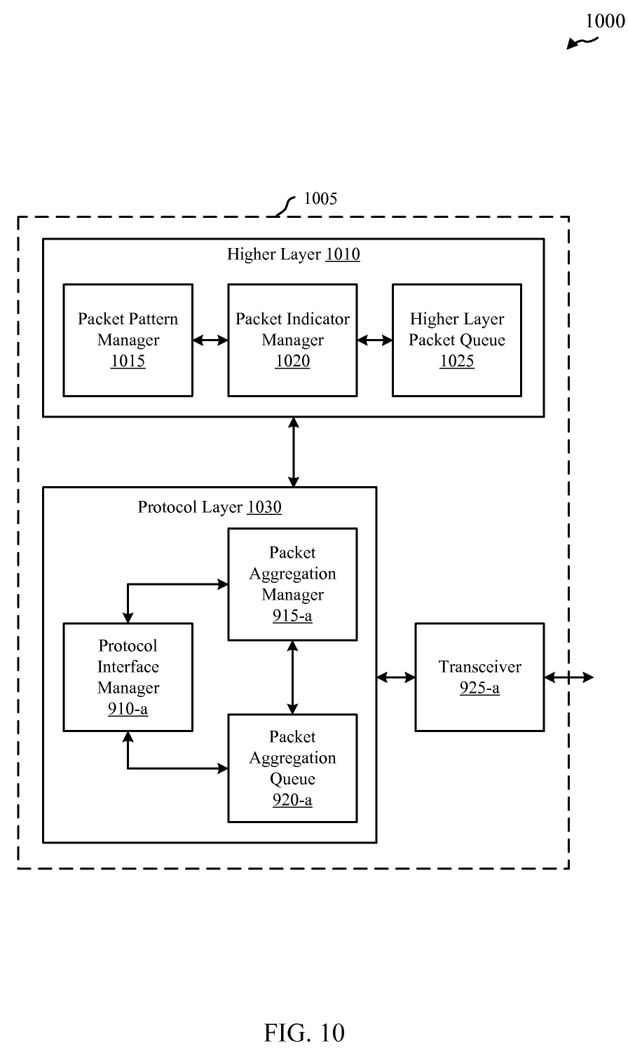

FIG. 10 shows a block diagram 1000 of a device 1005 for aggregating one or more packets based on an indication from an higher layer of whether more packets are available in the higher layer, in accordance with various embodiments. The device 1005 may include an higher layer 1010, a protocol layer 1030, and/or a transceiver 925-a, each of which, in embodiments, may be communicably coupled with any or all of the other components. The higher layer 1010 may implement aspects of higher layer 305 described in reference to FIG. 3 or 4, and/or aspects of applications 510, the TCP/UDP stack 520, or the MAC layer 530 described in reference to FIG. 5. The protocol layer 1030 may implement one or more aspects of protocol layer 315 described in reference to FIG. 3 or 4, and/or aspects of the MAC layer 530 or PHY layer 540 described in reference to FIG. 5. The transceiver 925-a may be an example of transceiver 925 described in reference to FIG. 9. Device 1005 may be an example of STA 110 or an AP 105 as described in previous Figures.

The higher layer 1010 may include a packet pattern manager 1015, a packet indicator manager 1020, and/or a higher layer packet queue 1020, each of which, in embodiments, may be communicably coupled with any or all of the other components. The higher layer packet queue 1025 may implement one or more aspects of higher layer packet queue 310 described in reference to FIG. 3 or 4, and/or aspects of application queues 515, the TCP/UDP queue 525, and/or the MAC queue 535 described in reference to FIG. 5. The higher layer packet queue 1025 may receive and/or compile information such as one or more packets to be transmitted to a recipient device (e.g., an STA 110 or AP 105). The packet indicator manager 1020 may determine if any packets and/or how many packets are in the higher layer packet queue 1025. Based on this information, the higher layer packet queue 1025 may set an indicator to be included with the one or more packets in the higher layer packet queue 1025, with the indicator indicating whether more packets are available in the higher layer packet queue 1025 for transfer, for example, to the protocol layer 1030.

In some implementations, the packet pattern manager 1015 may collect and/or access information related to packets coming into the higher layer packet queue 1025 for transmission to a recipient device. The packet pattern manager 1015 may, for example, access information relating to patterns of data flow received at the higher layer 1010, which may correspond to the type, purpose, producer of one or more applicants running on the device 1005, etc. Based on the packet pattern information, the packet pattern manager 1015 may better inform the packet indicator manager 1020 of what indicator to attach to one or more packets in the higher layer packet queue 1025.

In some embodiments, the packet indicator manager 1020 and/or the packet pattern manager 1015 may implement one or more operations of processes 600 and/or 700 described above in reference to FIGS. 6 and/or 7. Once an indicator is attached to one of the packets in the higher layer packet queue 1025, the higher layer 1010 may transfer the one or more packets and the one or more indicators to the protocol layer 1030.

The protocol layer 1030 may include a protocol interface manager 910-a, a packet aggregation manager 915-a, and/or a packet aggregation queue 920-a, each of which, in embodiments, may be communicably coupled with any or all of the other components. The protocol interface manager 910-a, the packet aggregation manager 915-a, and the packet aggregation queue 920-a may each be examples of the protocol interface manager 910, the packet aggregation manager 915, and the packet aggregation queue 920 described above in reference to FIG. 9. Accordingly, the detailed functionality of these components will not be repeated here for the sake of brevity. The packet aggregation queue 920-a may additionally implement aspects of higher layer packet queue 310 described in reference to FIG. 3 or 4, and/or aspects of application queues 515, the TCP/UDP queue 525, or the MAC queue 535 described in reference to FIG. 5.

The protocol interface manager 910-a may receive the one or more packets and indicators from the higher layer packet queue 1025. The protocol interface manager 910-a may then direct the one or more packets to the packet aggregation queue 920-a and the one or more indicators to the packet aggregation manager 915-a. The packet aggregation manager 915-a may then direct the packet aggregation queue 920-a when to aggregate the packets in the queue 920-a based on the one or more indicators received from the higher layer 1010. The packet aggregation manager 915-a may weight (e.g., place more importance on) the received indicators more than one or more packet aggregations conditions (e.g., window size, wait time, etc.). In some aspects, the packet aggregation manager 915-a may decide when to instruct the packet aggregation queue 920-a to aggregate the packets in the queue 920-a via one or more operations of process 800 described in reference to FIG. 8.

The packet aggregation queue 920-a may then aggregate one or more packets in the queue 920-a based on instruction from the packet aggregation manager 915-a. The protocol layer (e.g., the packet aggregation queue 920-a) may then communicate the one or roe aggregated packets to the transceiver 925-a to be transmitted to a recipient device, such as an STA 110 or AP 105.

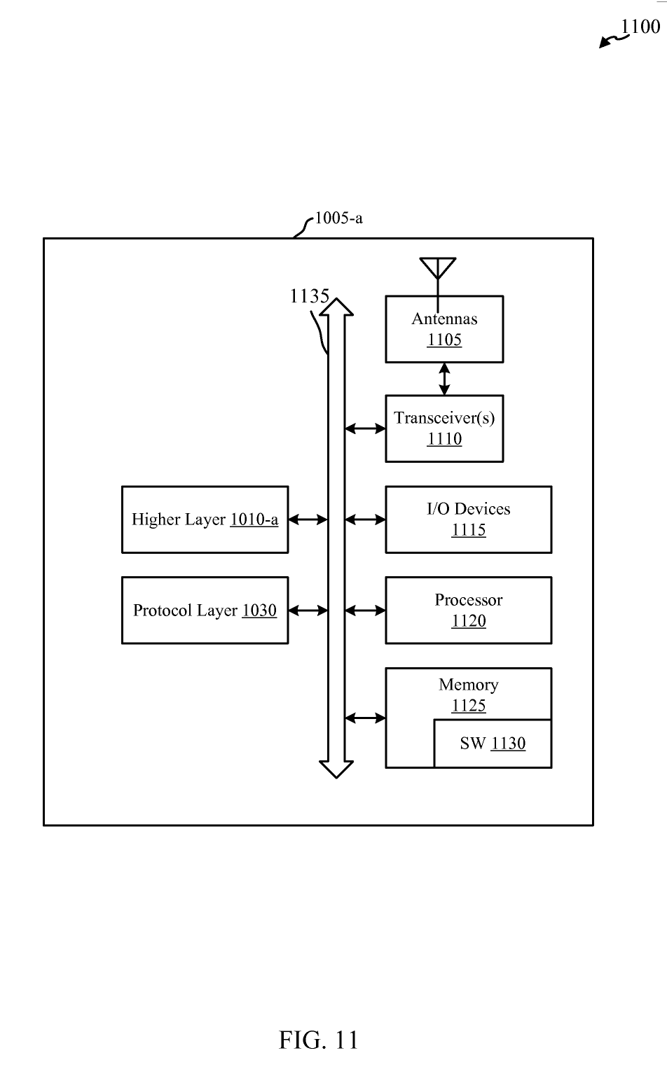

FIG. 11 is a block diagram 1100 of a device 1005-a configured for aggregating one or more packets based on an indication from an higher layer of whether more packets are available in the higher layer, in accordance with various embodiments. The device 1005-a may be an example of one or more aspects of a device 110 and/or AP 105 described with reference to previous Figures. The device 1005-a may also implement one or more aspect of an higher layer/higher layer packet queue and a protocol layer/protocol layer packet queue described above in reference to previous Figures, such as higher layer 1010 and protocol layer 1030 of FIG. 10. The device 1005-a may have any of various configurations, such as personal computers (e.g., laptop computers, netbook computers, tablet computers, etc.), smartphones, cellular telephones, PDAs, wearable computing devices, digital video recorders (DVRs), internet appliances, routers, gaming consoles, e-readers, display devices, printers, etc. The device 1005-a may have an internal power supply (not shown), such as a small battery, to facilitate mobile operation.

The device 1005-a includes antenna(s) 1105, transceiver(s) 1110, memory 1125, a processor 1120, and I/O devices 1115, each of which may be in communication, directly or indirectly, with each other, for example, via one or more buses 1135. The transceiver(s) 1110 may be configured to communicate bi-directionally, via the antennas 1105 with one or more wired or wireless links, such as any of links 115, and/or 120 described above in reference to FIGS. 1, 2, and/or 3. The transceiver(s) 1110 may include a modem configured to modulate the packets and provide the modulated packets to the antennas 1105 for transmission, and to demodulate packets received from the antennas 1105. The transceiver(s) 1110 may, in conjunction with the antennas 1105, transmit and receive packets, such as aggregated packets as described above. The device 1005-a may include a single antenna 1105, or the device 1005-a may include multiple antennas 1105. The device 1005-a may be capable of employing multiple antennas 1105 for transmitting and receiving communications in a multiple-input multiple-output (MIMO) communication system.

The memory 1125 may include random access memory (RAM) and read-only memory (ROM). The memory 1125 may store computer-readable, computer-executable software code 1130 containing instructions that are configured to, when executed, cause the processor 1120 to perform various functions described herein. Alternatively, the software 1130 may not be directly executable by the processor 1120 but may be configured to cause the computer (e.g., when compiled and executed) to perform functions described herein. The processor 1120 may include an intelligent hardware device, e.g., a central processing unit (CPU), a microcontroller, an application specific integrated circuit (ASIC), etc.

According to the architecture of FIG. 11, the device 1005-a may further include a higher layer 1010-a and a protocol layer 1030-a. By way of example, these components of device 1005-a may be in communication with some or all of the other components of the device 1005-a via bus 1135. Additionally or alternatively, functionality of these components may be implemented via the transceiver 1110, as a computer program product stored in software 1130, and/or as one or more controller elements of the processor 1120. In some embodiments, the higher layer 1010-a and/or protocol layer 1030-a may be implemented as subroutines in memory 1125/software 1130, executed by the processor 1120. In other cases, these modules may be implemented as sub-modules in the processor 1120 itself.

The higher layer 1010-a may implement a packet pattern manager 1015, a packet indicator manager 1020, and/or a higher layer packet queue 1020 with some or all of the functionality described above in reference to FIG. 10. Similarly, the protocol layer 1030-a may implement a protocol interface manager 910, a packet aggregation manager 915, and/or a packet aggregation queue 920 with some or all of the functionality described above in reference to FIGS. 9 and/or 10. The higher layer 1010-a and the protocol, layer 1030-a may enable the device 1005-a to aggregate one or more packets at the protocol layer 1030-a based on an indication from the higher layer 1010-a indicating that one or more additional packets are available at the higher layer 1010-a, in accordance with various embodiments. The transceiver(s) 1110 may direct the aggregated packets from the protocol layer 1030-a to antennas 1105 to be transmitted. The components of device 1005-a may further implement the procedures described above for aggregating one or more packets based on an indication from an higher layer of whether more packets are available in the higher layer, and will not be repeated here.

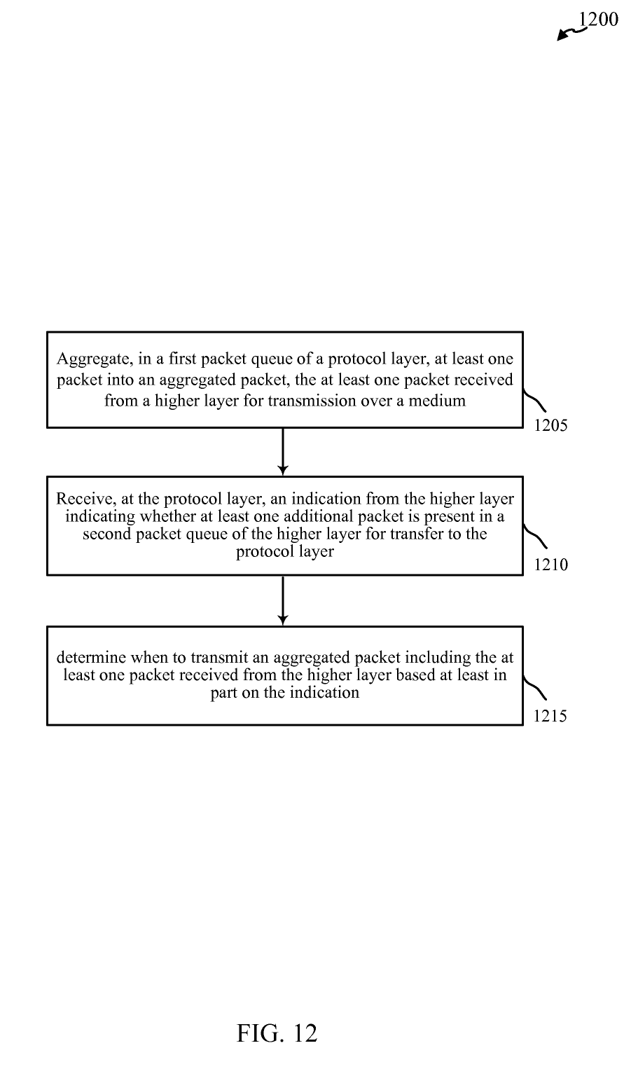

FIG. 12 is a flow chart illustrating one example of a method 1200 for aggregating one or more packets based on an indication from an higher layer of whether more packets are available in the higher layer, in accordance with various embodiments. The method 1200 may be implemented by devices 905 or 1005 described in reference to FIG. 9, 10, or 11, a STA 110 or AP 105 described in reference to FIG. 1, 2, or 3, a protocol layer 315 or 1030 described in reference to FIG. 3, 4, 10, or 11, or one or more of the MAC layer 530 and/or PHY layer 540 described in FIG. 5. The method 1200 may also be implemented at least in part by protocol layer packet queue 320 described in reference to FIG. 3, 4, or 6, or the MAC queue 535 or PHY queue 545 described in reference to FIG. 5. In some embodiments, a device such as one of the devices 905, 1005, 110, or 105 may execute one or more sets of codes to control the functional elements of the device to perform the functions described below.

At block 1205, a first packet queue of a protocol layer, such as packet queue 320, 535, 545, or 920, may aggregate at least one packet into an aggregated packet, the at least one packet received from a higher layer, such as layer 305, 510, 520, 530, or 1010, for transmission over a medium.

At block 1210, the protocol layer may receive an indication, such as PIs 435, 556, 561, or 567, from the higher layer indicating of whether at least one additional packet is present in a second packet queue, such as queue 310, 515, 525, 535, or 1025 of the higher layer for transfer to the protocol layer. In some instances, the indication may be included in the one or more received packets, such as in the form of a flag in the packet header. In some aspects, the indication may include information indicating a number of packets present in the second packet queue of the higher layer, whether the number of packets is greater than one a threshold, etc.

At block 1215, the protocol layer may determine when to transmit an aggregated packet including the at least one packet received from the higher layer based at least in part on the indication. In some instances, determining when to transmit an aggregate packet based at least in part on the received indication may override at least one packet aggregation condition (e.g., a wait time, window size, etc.). The aggregated packet may be transmitted to a destination device (e.g., a STA 110 or AP 105) over a wireless local area network (WLAN) radio channel.

Thus, the method 1200 may provide for aggregating one or more packets based on an indication from an higher layer of whether more packets are available in the higher layer. It should be noted that the method 1200 is just one implementation and that the operations of the method 1200 may be rearranged or otherwise modified such that other embodiments are possible.

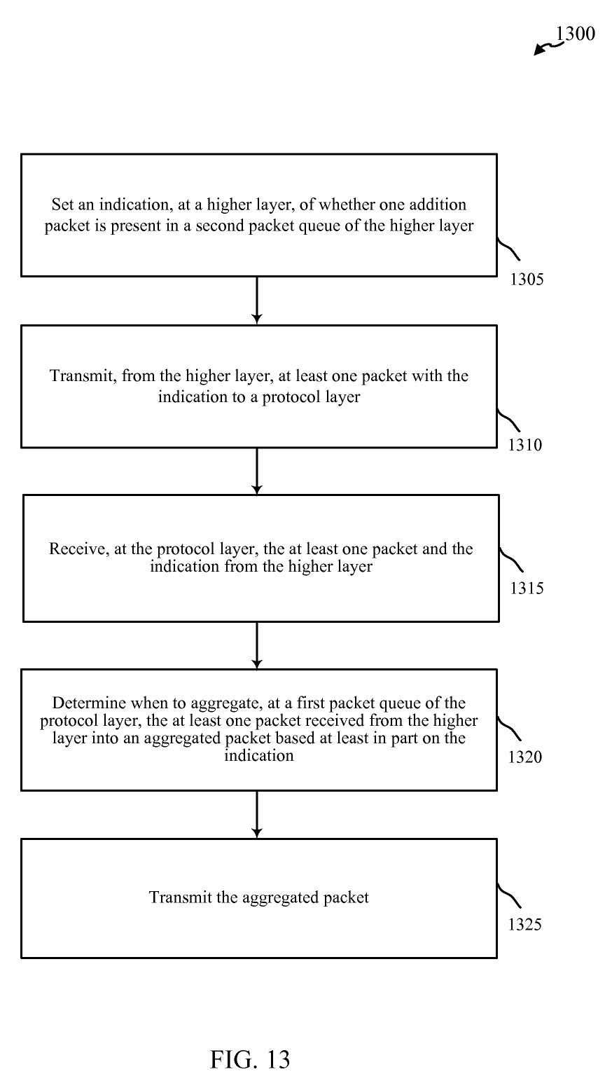

FIG. 13 is a flow chart illustrating one example of another method 1300 for aggregating one or more packets based on an indication from an higher layer of whether more packets are available in the higher layer, in accordance with various embodiments. The method 1300 may be implemented by device 1005 described in reference to FIG. 10 or 11, a STA 110 or AP 105 described in reference to FIG. 1, 2, or 3, an higher layer 305 or 1010 described in reference to FIG. 3, 4, 10, or 11, a protocol layer 315 or 1030 described in reference to FIGS. 3, 4, 10, and/or 11, or an application 510, a TCP/UDP stack 520, a MAC layer 530, or a PHY layer 540 described in FIG. 5. In some embodiments, a device such as one of the devices 905, 1005, 110, or 105 may execute one or more sets of codes to control the functional elements of the device to perform the functions described below.

At block 1305, a higher layer may set an indication of whether one addition packet is present in a second packet queue of the higher layer. In some instances, the higher layer may be one of an application 510, a TCP/UDP stack 520, and/or a MAC layer 530. In some aspects, the higher layer may set the indication based at least in part on information related to a pattern of packets arriving at the higher layer. The packet pattern information, for example, may include historical information related to data flows relative to one or more applications, frequency of data arriving at the higher layer, etc.

At block 1310, the higher layer may transmit at least one packet with the indication, to a protocol layer. In some aspects, the protocol layer may be a PHY layer 540 or a MAC layer 530.

At block 1315, the protocol layer may receive the at least one packet and the indication from the higher layer.

At block 1320, a first packet queue of the protocol layer may determine when to aggregate the at least one packet received from the higher layer into an aggregated packet based at least in part on the indication. In some cases, the protocol layer may be a PHY layer, such as PHY layer 540. In this scenario, the he aggregation may include MPDU aggregation at the PHY layer 540.

At block 1325, the protocol layer, for example, may transmit the aggregated packet to a recipient device, such as an STA 110 or AP 105.

Thus, the method 1300 may provide for aggregating one or more packets based on an indication from an higher layer of whether more packets are available in the higher layer. It should be noted that the method 1300 is just one implementation and that the operations of the method 1300 may be rearranged or otherwise modified such that other embodiments are possible. One or more aspects of the method 1200 or 1300 may in some cases be omitted or combined.

Techniques described herein may be used for various wireless communications systems such as CDMA, TDMA, FDMA, OFDMA, SC-FDMA, and other systems. The terms “system” and “network” are often used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies. The description above, however, describes a WLAN system for purposes of example, and WLAN terminology is used in much of the description above, although the techniques are applicable beyond WLAN systems.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method for packet aggregation in a wireless communication system, the method comprising:
aggregating, in a first packet queue of a protocol layer, at least one packet into an aggregated packet, the at least one packet received from a higher layer for transmission over a medium;
receiving, at the protocol layer, an indication from the higher layer of whether at least one additional packet is present in a second packet queue of the higher layer for transfer to the protocol layer; and
determining when to transmit an aggregated packet comprising the at least one packet received from the higher layer based at least in part on the indication.

2. The method of claim 1, further comprising:
receiving the at least one packet from the higher layer, wherein the indication is included in the at least one received packet.

3. The method of claim 2, wherein the indication included in the at least one packet comprises a flag in a packet header of the at least one received packet.

4. The method of claim 1, wherein receiving the indication comprises:
receiving information indicating a number of packets of the at least one additional packet in the second packet queue of the higher layer.

5. The method of claim 4, wherein the information indicating the number of packets of the at least one additional packet comprises an indication of whether the number of packets is greater than a threshold.

6. The method of claim 1, further comprising:
determining the indication, by the higher layer, based at least in part on a pattern of packets received at the second packet queue.

7. The method of claim 1, wherein determining when to transmit an aggregated packet comprises:
overriding at least one packet aggregation condition based at least in part on the indication comprising an indication that no additional packets are present in the second packet queue of the higher layer for transfer to the protocol layer.

8. The method of claim 7, wherein the at least one packet aggregation condition comprises at least one of an aggregation wait time and an aggregation window size.

9. The method of claim 1, further comprising:
transmitting the aggregated packet to a destination device over a wireless local area network (WLAN) radio channel.

10. The method of claim 1, wherein the higher layer comprises a medium access control (MAC) layer, and the protocol layer comprises a physical (PHY) layer.

11. The method of claim 1, wherein the higher layer comprises one of a group consisting of an application layer, a user datagram protocol (UDP) layer, and a transmission control protocol (TCP) layer, and the protocol layer comprises one of a MAC layer or a PHY layer.

12. The method of claim 1, wherein the higher layer and the protocol layer are part of a device comprising one of a group consisting of a base station and a mobile device.

13. The method of claim 1, wherein the at least one packet comprises at least one medium access control (MAC) protocol data unit (MPDU), and the aggregated packet comprises an aggregated MPDU (AMPDU) for transmission over a wireless local area network (WLAN).

14. A wireless communication device, comprising:
a protocol layer comprising:
a protocol interface to receive at least one packet from a higher layer for transmission over a medium, the at least one packet including an indication from the higher layer indicating whether at least one additional packet is present in a second packet queue of the higher layer for transfer to the protocol layer;
a packet aggregation queue, in communication with the protocol interface, to aggregate the at least one received packet into an aggregated packet; and
a packet aggregation manager, in communication with the protocol interface and the packet aggregation queue, to determine when to instruct the packet aggregation queue to aggregate the at least one packet received from the higher layer based at least in part on the indication.

15. The device of claim 14, wherein the protocol layer comprises one of a MAC layer and a PHY layer.

16. The device of claim 14, wherein the indication comprises:
information associated with a number of packets of the at least one additional packet in the second packet queue of the higher layer.

17. The device of claim 14, wherein the indication is set by the higher layer based at least in part on a pattern of packets received at the second packet queue.

18. The device of claim 14, wherein determining when to instruct the packet aggregation queue to aggregate the at least one packet comprises:
overriding at least one packet aggregation condition based at least in part on the indication comprising an indication that no additional packets are present in the second packet queue of the higher layer for transfer to the protocol layer.

19. The device of claim 18, wherein the at least one packet aggregation condition comprises at least one of an aggregation wait time and an aggregation window size.

20. A computer program product operable on a wireless communication device, the computer program product comprising a non-transitory computer-readable medium storing instructions for:
aggregating, in a first packet queue of a protocol layer, at least one packet into an aggregated packet, the at least one packet received from a higher layer for transmission over a medium;
receiving, at the protocol layer, an indication from the higher layer of whether at least one additional packet is present in a second packet queue of the higher layer for transfer to the protocol layer; and
determining when to transmit an aggregated packet comprising the at least one packet received from the higher layer based at least in part on the indication.
